(19) United States
(12) Patent Application Publication
(10) Pub. No.: US 2024/0161038 A1
(43) Pub. Date: May 16, 2024

(54) Locality Sensitive Hashing to Generate N-dimensional Vectors of Risks and Conduct Risk Analysis

(71) Applicant: Meta Platforms, Inc., Menlo Park, CA (US)

(72) Inventor: Brandon Sloane, Lancaster, SC (US)

(73) Assignee: Meta Platforms, Inc., Menlo Park, CA (US)

(21) Appl. No.: 18/054,774

(22) Filed: Nov. 11, 2022

(51) Int. Cl. G06Q 10/06

(52) U.S. Cl. CPC G06Q 10/0635

(57) ABSTRACT

Systems, apparatuses and methods provide technology that identifies first characteristics of a first risk associated with a system and applies a locality sensitive hashing process to the first characteristics to map the first characteristics to first buckets of a plurality of buckets. The technology further generates a first vector based on the first characteristics being mapped to the first buckets, and identifies a mitigation plan to at least partially mitigate the first risk based on the first vector.

### TECHNICAL FIELD

Examples of the disclosure generally relate to risk management and classification. More particularly, examples relate to executing a locality sensitive hashing process on risk characteristics to generate a vector and determining a mitigation plan for the risk based on the vector.

### BACKGROUND

There are various frameworks and taxonomies for classifying risks. Such frameworks and taxonomies may be unable to accurately identify when risks are related to one another. For example, risks may include many distinct and varied characteristics that are difficult for a person or system to synthesize into an overarching risks analysis. Thus, the various frameworks and taxonomies do not really help with identifying the relatedness between two identified risks and how such risks are related.

### SUMMARY

Some examples include at least one computer readable storage medium comprising a set of instructions, which when executed by a computing device, cause the computing device to identify first characteristics of a first risk associated with a system. The computing device further applies a locality sensitive hashing process to the first characteristics to map the first characteristics to first buckets of a plurality of buckets, generates a first vector based on the first characteristics being mapped to the first buckets, and identifies a mitigation plan to at least partially mitigate the first risk based on the first vector.

Some examples include a system comprising one or more processors, and a memory coupled to the one or more processors, the memory comprising instructions executable by the one or more processors. The one or more processors being operable when executing the instructions to identify first characteristics of a first risk associated with a system, apply a locality sensitive hashing process to the first characteristics to map the first characteristics to first buckets of a plurality of buckets, generate a first vector based on the first characteristics being mapped to the first buckets, and identify a mitigation plan to at least partially mitigate the first risk based on the first vector.

Some examples include a method comprising identifying first characteristics of a first risk associated with a system and applying a locality sensitive hashing process to the first characteristics to map the first characteristics to first buckets of a plurality of buckets. The method further includes generating a first vector based on the first characteristics being mapped to the first buckets, and identifying a mitigation plan to at least partially mitigate the first risk based on the first vector.

### BRIEF DESCRIPTION OF THE DRAWINGS

The various advantages of the examples will become apparent to one skilled in the art by reading the following specification and appended claims, and by referencing the following drawings, in which:

FIG. 1 is an example of a risk classification and mitigation architecture according to an example of the disclosure;

FIG. 2 is a natural language analysis process according to an example of the disclosure;

FIG. 3 is an example of a risk identification system according to an example of the disclosure;

FIG. 4 is an example a table generation process according to an example of the disclosure;

FIG. 5 is a flowchart of an example of a method of conducting risk analysis according to an example of the disclosure;

FIG. 6 is an example of a vector graph according to an example of the disclosure;

FIG. 7 illustrates an example network environment associated with a social-networking system according to an example of the disclosure;

FIG. 8 illustrates an example social graph according to an example of the disclosure; and

FIG. 9 illustrates an example computer system according to an example of the disclosure.

### DESCRIPTION EXAMPLE

Examples of the disclosure relate to a risk classification and management system. Examples herein apply a locality sensitive hashing (LSH) process to first characteristics of a first risk to map the first characteristics to buckets of a plurality of buckets, generate a first vector based on the first characteristics being mapped to the first buckets and identify a mitigation plan to at least partially mitigate the first risk based on the first vector. For example, the first vector may be compared to other vectors associated with other risks to identify similar vectors with associated risk profiles and mitigation strategies. The first risk may be mitigated by adopting at least part of the mitigation strategies. Mapping the first risk and other risks to vector space enables geometric representation of the relatedness of the first risk and other risks allowing examples to leverage linear algebraic approaches (e.g., during comparison) to deliver insightful and intelligent outcomes. Examples convert the risk into a vector format through a Locality Sensitive Hashing (LSH) and n-dimensional vectorization process to leverage vector space analysis techniques. Doing so enables a way to measure relatedness of multivariable and complicated risks to enhance technical fields including risk management, risk awareness, risk analysis and risk mitigation.

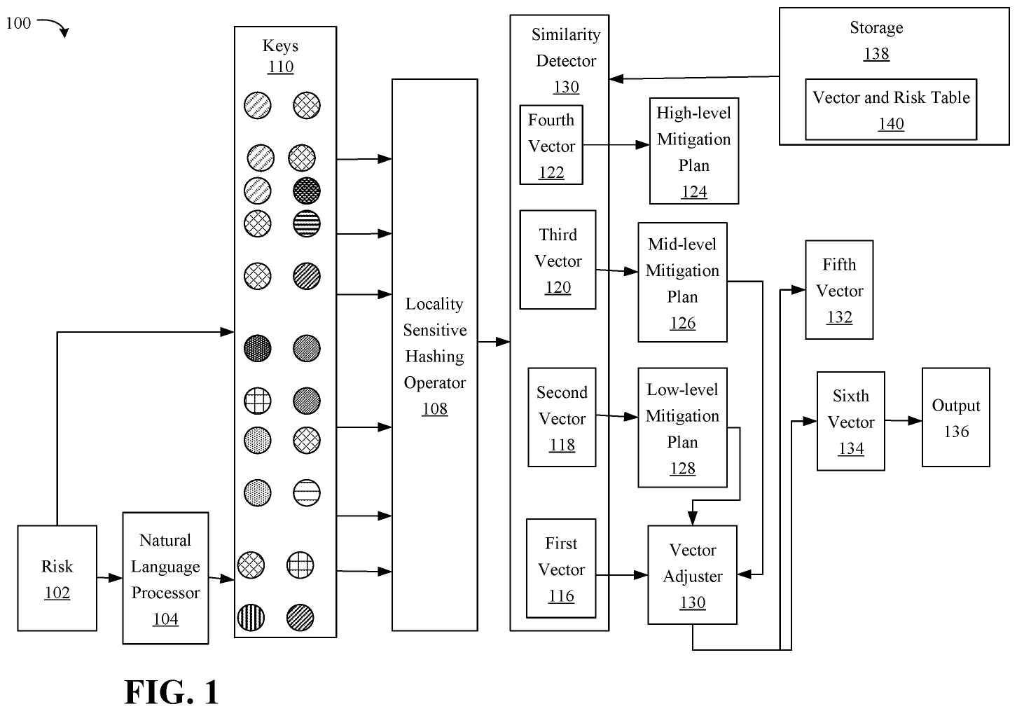

Turning now to FIG. 1, a risk classification and mitigation architecture 100 is illustrated. The risk classification and mitigation architecture 100 may be a computing architecture. For example, the risk classification and mitigation architecture 100 may be implemented in a computing device including a memory and processor, computing system (e.g., hardware, configurable logic, fixed-function logic hardware, at least one computer readable storage medium comprising a set of instructions for execution, etc.). Any and all components of the risk classification and mitigation architecture 100 may be implemented as a computing device, non-transitory computer readable storage medium, server, mobile device, etc.

In this example, a risk 102 is identified and/or provided to the risk classification and mitigation architecture 100. For example, a first part of the risk 102 may be provided by the user through a survey, multiple-choice reply, etc. The first part may be in a first format that is hashable by LSH operator 108.

In some examples, the risk classification and mitigation architecture 100 provides the user with a series of prompts to gather data attributes and characteristics about a particular risk which the user and/or risk classification and mitigation architecture 100 is to analyze. These may be manually entered and/or automated/derived from other systems of interest. Such entries may be the first part of the risk 102 and may be directly hashable.

A second part of the risk 102 may be provided in a second format that is not directly hashable by the LSH operator 108. For example, the second part of the risk 102 may be in a textual format authored by the user (e.g., free-form style). In order to handle the second part of the risk 102, some examples include natural language processor 104 that executes natural language processing on the second part to identify relevant content of the text and provide the relevant content to the LSH operator 108 while ignoring irrelevant content. In some examples, the natural language processor 104 receives a natural language input of the risk 102, applies natural language processing to the natural language input to filter the natural language input into first text that bypasses second text of the natural language input. The first text (but not the second text) may be stored as part of keys 110.

Keys 110 may represent different characteristics of the risk 102. For example, each circle may correspond to a different characteristic of the risk 102. That is, risk 102 may include multi-dimensional characteristics. As an example, the risk 102 may reflect the risk of a network. The network may comprise hundreds of different components. A first characteristic may reflect how many of the components are computing devices, a second characteristic may reflect how many of the computing devices leave an office (e.g., laptops that are taken home), a third characteristic may reflect how many of computing devices are up-to date on software updates, a fourth characteristic may reflect how many of the computing devices operate virus protection, a fifth risk may represent how many firewalls are installed, a sixth risk may represent if servers are actively scan for fraudulent emails (e.g., phishing and viruses, etc.), etc. While the risk 102 above is discussed as reflecting the risk of a network, it will be understood that the risk 102 may reflect any type of risk for any environment (e.g., medical risk, financial risk, natural disaster risk, vehicle risk, etc.).

Some examples of characteristics of the risk 102 may include whether there is data involved, what sort of data, and under what situations would that data change. As noted, the risk classification and mitigation architecture 100 is flexible in implementation. Some examples relate to a broader swath of risk management related attributes that help to define and derive likelihood and impact for a particular risk. The characteristics may be represented by the risk 102 regardless of the specific nature of the characteristics.

The LSH operator 108 may receive the keys 110 and execute LSH (e.g., a simhash function or a minhash function) on the keys 110. A simhash function is a technique for quickly estimating how similar two sets are. Simhash may include similar items being hashed to similar hash values (e.g., based on bitwise hamming distance between hash values). The minhash function, or the min-wise independent permutations locality sensitive hashing scheme, is another technique for estimating how similar two sets are. For example, minhash may include a Jaccard similarity coefficient which is an indicator of the similarity between two sets. In Equation 1 below, let U be a set, and A and B be subsets of U, then the Jaccard index is defined to be the ratio of the number of elements of their intersection and the number of elements of their union:

$$J ( A , B ) = \frac{\vert A ⋂ B \vert}{\vert A ⋃ B \vert} \qquad Equation 1$$

This value is 0 when the two sets are disjoint, 1 when they are equal, and strictly between 0 and 1 otherwise. Two sets are more similar (i.e. have relatively more members in common) when their Jaccard index is closer to 1. The goal of MinHash is to estimate J(A,B) quickly, without explicitly computing the intersection and union.

For example, let h be a hash function that maps the members of U to distinct integers, let perm be a random permutation of the elements of the set U, and for any subset S of U define hₘᵢₙ(S) to be the minimal member of S with respect to h∘perm. Some examples may apply hₘᵢₙ to both A and B, and assuming no hash collisions, examples determine that are equal (hₘᵢₙ(A)=hₘᵢₙ(B)) if and only if among all elements of |A∪B|, the element with the minimum hash value lies in the intersection |A∪B|. The probability of this being true is approximately the Jaccard index, therefore:

Pr[hₘᵢₙ(A)=hₘᵢₙ(B)]=J(A,B) Equation 2

For example, the probability that hₘᵢₙ(4)=hₘᵢₙ(B) is true is equal to the similarity J(A,B), assuming drawing perm from a uniform distribution. In other words, if r is the random variable that is one when hₘᵢₙ(A)=hₘᵢₙ(B) and zero otherwise, then r is an unbiased estimator of J(A,B). r has too high a variance to be a useful estimator for the Jaccard similarity on its own, because is always zero or one. A Mini-lash scheme reduces this variance by averaging together several variables constructed in the same way.

A normal hashing function may accept a string as an input and maps the string to a random, fixed length representation. In risk ingestion terms, such a hash model would take a series of data attributes (i.e., characteristics) about an identified risk and convert the attributes into a fixed length vector representation of the attributes. The random generation of fixed length representations results in difficulty identifying similar risks to draw insights about the similar risks.

A LSH function may accept a string as an input, and then maps the string to a fixed length representation but does so in such a way that the input data attributes will influence the representation. In other words, randomness of outputs is constrained based on input variables. In risk ingestion terms, an LSH function groups similar risks together as vector representations. That is, the LSH function will cluster similar characteristics together to be proximal to each other. For example, LSH may include different functions (known as LSH families) to hash data points into buckets so that data points near each other (e.g., similar characteristics of risk) are located in the same buckets with high probability, while data points far from each other (e.g., dissimilar characteristics of risk) are likely to be in different buckets. Thus, the LSH operator 108, which implements an LSF function(s), will group similar characteristics into similar buckets.

A vector may be generated based on the groupings of the keys 110. For example, each respective characteristic of the characteristics of the risk 102 is represented as a respective key, and the respective key may be assigned into a bucket by the LSH operator 108. An entry in the first vector 116 that corresponds to the respective characteristic may be assigned a value corresponding to the bucket (e.g., 1, 2, 3, etc.) that the respective characteristic is assigned. Thus, the characteristics of the risk 102 may be represented as the first vector 116, where each dimension of the first vector 116 corresponds to a different characteristic. Thus, each of the characteristics is represented as a dimension of the first vector 116.

A storage 138 may be accessed to retrieve vectors from the vector and risk table 140. For example, the risk classification and mitigation architecture 100 may have previously generated vectors that were generated based on previously identified risks. Thus, the vector and risk table 140 may store previously identified vectors in association with corresponding risks. Further, each of the previously identified risks may be stored in association with mitigation strategies that reduced the potential ramifications of the previously identified risks.

For example, suppose that a second risk previously occurred. The second risk may be associated with undesirable outcomes (e.g., network failures, poor health outcomes, etc.). In order to reduce the likelihood of the undesirable outcomes from occurring, a low-level mitigation plan 128 may have been implemented. The risk classification and mitigation architecture 100 may therefore determine that the second risk is to be stored in association with the low-level mitigation plan 128. The low-level mitigation plan 128 at least partially mitigated the second risk. Further, in order to facilitate comparisons between different risks, the risk classification and mitigation architecture 100 may convert the second risk into a vector format, similar to as described above, to generate the second vector 118. Thus, the second vector 118 may be stored in association with the low-level mitigation plan 128. Similarly, the third vector 120 (e.g., representing a third risk) may be stored in association with the mid-level mitigation plan 126 which was implemented to offset the third risk. Likewise, the fourth vector 122 (e.g., representing a fourth risk) may be stored in association with the high-level mitigation plan 124 which was implemented to offset the fourth risk.

In this example, the second vector 118, the third vector 120 and the fourth vector 122 are retrieved from the vector and risk table 140. The second vector 118 is associated with the low-level mitigation plan 128 (e.g., a less severe mitigation plan). The third vector 120 is associated with a mid-level mitigation plan 126 (e.g., medium severity mitigation plan). The fourth vector 122 is associated with a high-level mitigation plan 124 (e.g., a high severity mitigation plan).

Examples herein determine if the first vector 116 is similar to one or more of the second vector 118, third vector 120 or fourth vector 122. If the first vector 116 is similar to one or more of the second vector 118, third vector 120 or fourth vector 122 a corresponding mitigation plan may be implemented. For example, some examples include an analytics and intelligence aspect which leverages a number of vector and matrix similarity algorithms to examine relatedness from a geographic and weighted dimensional aspect. For example, using eigen-decomposition to examine the most significant factors in the first vector 116, second vector 118, third vector 120 and fourth vector 122 (e.g., n-dimensional representations) allows examples to derive insights into risks that are the most related along a significant axis. This permits examples to draw insights whether the risk 102 needs to be prioritized and modified through remediation efforts based on vector analysis and comparison. Some examples may further calculate the similarity between two vectors based on Euclidian distance, Cosine similarity, etc.

In this example, the first vector 116 is compared to each of the second vector 118, third vector 120 and fourth vector 122. If the first vector 116 is found to be dissimilar to each of the second vector 118, third vector 120 and fourth vector 122, the first vector 116 may be classified as a negligible risk and no action is need. If however, the first vector 116 is found to be similar one or more of the second vector 118, third vector 120 and fourth vector 122, examples may determine that a corresponding plan of the low-level mitigation plan 128, the mid-level mitigation plan 128 and the high-level mitigation plan 124 may be implemented to mitigate the risk 102.

In this example, the first vector 116 is found to be similar to the third vector 120. For example, a similarity measurement (e.g., Euclidean Distance, vector and matrix similarity algorithms, eigen-decomposition, etc.) between the third vector 120 and the first vector 116 may meet a threshold. Examples determine that the mid-level mitigation plan 126 may therefore be implemented to reduce negative outcomes related to the risk 102.

In this example, the first vector 116 is additionally found to similar to the second vector 118. For example, a similarity measurement (e.g., Euclidean Distance, vector and matrix similarity algorithms, eigen-decomposition, etc.) between the second vector 118 and the first vector 116 may meet the threshold. The risk classification and mitigation architecture 100 determine that the low-level mitigation plan 128 may therefore be implemented to reduce negative outcomes related to the risk 102.

The first vector 116 may be determined to not be similar to the fourth vector 122. That is, a similarity measurement between the fourth vector 122 and the first vector 116 may be below a threshold. Thus, the high-level mitigation plan 124 may be bypassed and will not be applied to the risk 102.

In some examples, rather than implementing both the mid-level mitigation plan 126 and the low-level mitigation plan 128 with immediate effect, the mid-level mitigation plan 126 and the low-level mitigation plan 128 may be analyzed to determine an efficient and effective plan that balances user needs and flexibility, and/or result in the greatest reduction in severity of the risk 102.

To analyze an effectiveness of the mid-level mitigation plan 126 and the low-level mitigation plan 128 as applied to the risk 102, examples may provide the mid-level mitigation plan 126 and the low-level mitigation plan 128 to a vector adjuster 130.

For example, the vector adjuster 130 receives the first vector 116. The vector adjuster 130 adjusts the first vector 116 based on the mid-level mitigation plan 126 to generate a fifth vector 132. For example, the vector adjuster 130 may adjust characteristics of the first vector 116 that would be impacted by implementing the mid-level mitigation plan 126. For example, the mid-level mitigation plan 126 may include upgrading vulnerable computing devices of a computing network associated with the risk 102 to security-enhanced devices. Thus, a characteristic of the first vector 116 that represents the computing devices of the computing network may be adjusted to reflect that the vulnerable computing devices are removed and replaced with the security-enhanced devices. Thus, the vector adjuster 130 may modify the first vector 116 to reflect each adjustment of the mid-level mitigation plan 126 that would result in a characteristic of the first vector 116 being modified.

Similarly, the vector adjuster 130 may modify the first vector 116 based on the low-level mitigation plan 128. That is, the vector adjuster 139 adjusts the first vector 116 to reflect each adjustment of the low-level mitigation plan 128 that would result in a characteristic of the first vector 116 being changed to generate the sixth vector 134.

In some examples, the vector adjuster 130 may adjust the keys 110 based on the mid-level mitigation plan 126 (e.g., modify a first key to reflect a change in status, number, quantity and/or value). For example, if the mid-level mitigation plan 126 is implemented, one or more of the keys 110 may be adjusted to reflect changes in the functioning of the network associated with the risk 102 based on the mid-level mitigation plan 126. For example, the keys 110, which are adjusted based on the mid-level mitigation plan 126, may be processed by the LSH operator 108 to generate the fifth vector 132. Likewise, the vector adjuster 130 may be modified to adjust keys 110 based on the low-level mitigation plan 128. The keys 110, which are adjusted based on the low-level mitigation plan 128, may then be processed by the LSH operator 108 to generate the sixth vector 134.

In order to select whether the mid-level mitigation plan 126 or the low-level mitigation plan 128 is to be implemented, some examples analyze the sixth vector 134 and the fifth vector 132. For example, similar to as described above, the fifth vector 132 may be compared to other risk vectors of the vector and risk table 140. If the fifth vector 132 is similar to other risk vectors (e.g., similarity metric above a threshold), the fifth vector 132 may be considered to have risks associated with the other risk vectors (e.g., have a level of risk represented by the other risk vectors). Similarly, the sixth vector 134 may be compared to other risk vectors of the vector and risk table 140 to identify whether the sixth vector 134 is associated with any risks.

A lowest risk vector of the fifth vector 132 and the sixth vector 134 may be selected. In this example, the sixth vector 134 from the fifth vector 132 and the sixth vector 134 may be determined to have a lowest risk profile. For example, the fifth vector 132 may be determined to be similar to another vector from the vector and the risk table 140 that is associated with a significantly high risk. The sixth vector 134 may be determined to be similar to no vector from the vector and risk table 140, or a low risk vector from the vector and the risk table 140 that is associated with a low risk. Thus, the sixth vector 134 and/or low-level mitigation plan 128, which corresponds to the sixth vector 134, may be selected as an output 136. For example, the sixth vector 134 and/or low-level mitigation plan 128 may be automatically implemented to reduce the risk 102 or is provided to a user.

Some examples may further consider cost. For example, even if a mitigation plan would result in significantly reduced risk, the mitigation plan may be bypassed if the cost is above a threshold.

Thus, examples leverage prioritization and relatedness insights to generate remediation recommendations and remediation schedules which allows an enterprise to action risk items in a logical manner. Leveraging data driven insights in this way further enables focusing on the important risk areas and grouping related risks together so as to reduce unnecessary overhead and duplicative efforts to identify mitigation strategies.

Furthermore, examples implement an LSH algorithm that operates to cluster similarly defined items. The items would be different risks which have been gathered and ingested. LSH implementations then cluster related risks together into vector representations which are geographically closer together. This clustering allows examples to run additional analysis against a particular subsets of risks.

As a detailed example, consider a computing system with five different risks. Three of the risks are related to the availability of the computing system and the other two are related to how the computing system handles system access. Examples ingest these five risks to generate a vector LSH representation with the LSH operator 108. Due to how examples have weighted the different aspects of the risks, the vector representation ends up clustering the three availability related risks together and the two access related risks together. Geometrically, the vectors representations would be represented with n-dimensional vectors shooting off in generally two different directions. Doing so allows identifying relevant risks within the cluster of the availability risks. For example, vector comparison math may be executed to determine which individual risk presents the most potential for damage along that particular direction. Examples may effectively measure risks against each other using geometric and dimensional math, enabled by LSH clustering.

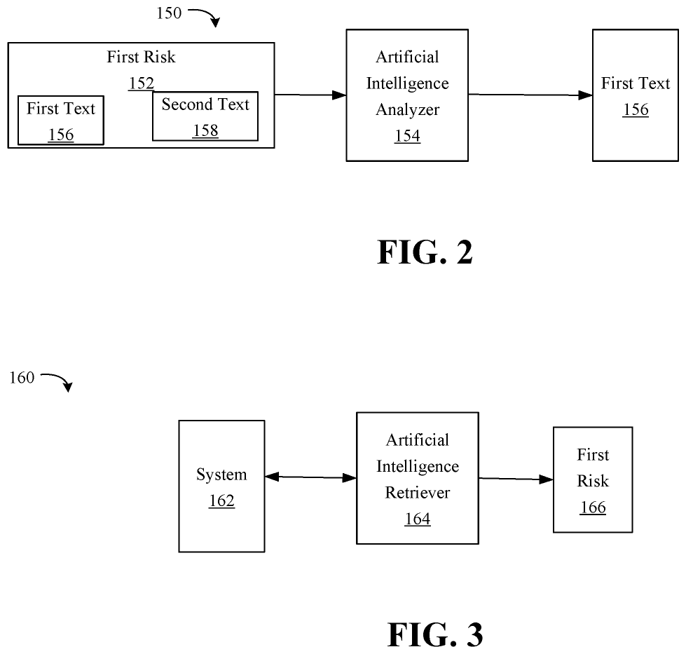

Turning now to FIG. 2, a natural language analysis process 150 is illustrated. The natural language analysis process 150 identifies a first risk 152. The natural language analysis process 150 may generally be implemented with the examples described herein, for example, the risk classification and mitigation architecture 100 (FIG. 1) already discussed.

A first risk 152 is provided. The first risk 152 may be in a free form text form and includes first text 156 and second text 158. For example, a user may describe aspects of a system in a free form manner. For example, a user may write comments related to different security parameters of a system. An artificial intelligence analyzer 154 may analyze the free form text to determine subject matter of the free form text. For example, the artificial intelligence analyzer 154 may identify and extract key terminologies as being relevant for risk analysis and output such identified key terminologies as part of the first text 156. For example, the artificial intelligence analyzer 154 receives a natural language input of the first risk 152, applies natural language processing to the natural language input to filter the natural language input into the first text 156 that bypasses second text 158 of the natural language input.

Although not illustrated, examples may generate a first vector (similar to as described above and with an LSH process) based on the first text 156 while bypassing the second text 158 when forming the first vector. That is, the second text 158 is not considered when generating the first vector.

FIG. 3 illustrates a risk identification system 160. The risk identification system 160 may generally be implemented with the examples described herein, for example, the risk classification and mitigation architecture 100 (FIG. 1) and/or natural language analysis process 150 (FIG. 2) already discussed.

System 160 may be a computing system, for example a computing system, a network, communication network, autonomous vehicle, etc. In this example, an artificial intelligence retriever 164 analyzes the system 162 for risks. For example, the artificial intelligence retriever 164 may access the system 162 to analyze the system 162 and generate a risk profile. For example, the artificial intelligence retriever 164 may identify characteristics of the system 162 that relate to risk (e.g., cataloguing computing devices, identifying if the devices are up-to date on patches, software updates, etc.), and store the characteristics as the first risk 166.

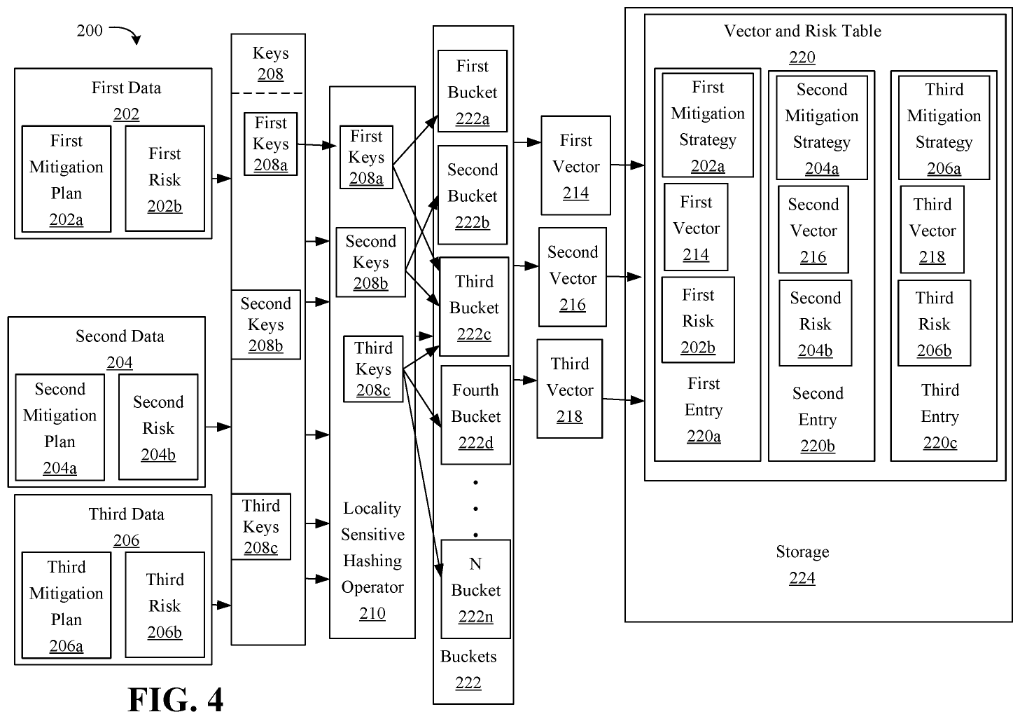

FIG. 4 illustrates a table generation process 200 to generates a vector and risk table 220. The table generation process 200 may be a computing architecture. For example, the table generation process 200 may be implemented in a computing device including a memory and processor, computing system (e.g., hardware, configurable logic, fixed-function logic hardware, at least one computer readable storage medium comprising a set of instructions for execution, etc.). Any and all components of the table generation process 200 may be implemented as a computing device, non-transitory computer readable storage medium, server, mobile device, etc. The table generation process 200 may generally be implemented with the examples described herein, for example, the risk classification and mitigation architecture 100 (FIG. 1), natural language analysis process 150 (FIG. 2) and/or risk identification system 160 (FIG. 3) already discussed.

The table generation process 200 may identify and/or be provided with a plurality of different data. Each data may comprise a different risk and mitigation plan to reduce the risk. For example, the different data may be historical data that includes verified risks and proven mitigation strategies that reduced the verified risks.

In this example, first data 202 comprises a first risk 202b and a first mitigation plan 202a that was implemented to mitigate the first risk 202b. In some examples, the first risk 202b was verified as reducing the severity of the first risk 202b. Similarly, second data 204 comprises a second risk 204b and a second mitigation plan 204a that was implemented to mitigate the second risk 204b. Likewise, the third data 206 comprises a third risk 206b and a third mitigation plan 206a that was implemented to mitigate the third risk 206b. Keys 208 may be generated based on the first data 202, the second data 204 and the third data 206.

The table generation process 200 extracts first keys 208a (e.g., first characteristics) from the first risk 202b. The table generation process 200 extracts second keys 208b (e.g., second characteristics) from the second risk 204b, and third keys 208c (e.g., third characteristics) from the third risk 206b. The keys 208 may be provided to the LSH operator 210 which executes LSH on the keys 208. That is, the LSH operator 210 clusters similar data points together into buckets 222. For example, first keys 208a are stored into first buckets 222a and third buckets 222c. Second keys 208b are sorted into second bucket 222b and third bucket 222c. Third keys are stored into third bucket 222c, fourth bucket 222d and N bucket 222n. Each respective bucket of the buckets 222 may have a different corresponding value assigned to the respective bucket.

First, second and third vectors 214, 216, 218 are generated based on the sorting of the keys 208 into the buckets 222. For example, a first vector 214 represents the first risk 202b and is generated based on the sorting of the first keys 208a of the first risk 202b into the first bucket 222a and the third bucket 222c. For example, the first vector 214 may comprise a first value of the first bucket 222a and a third value of the third bucket 222c.

The second vector 216 represents the second risk 204b and is generated based on the sorting of the second keys 208b into the second bucket 222b and the third bucket 222c. For example, the second vector 216 may comprise the second value of the second bucket 222b and the third value of the third bucket 222c.

The third vector 218 represents the third risk 206b and is generated based on the sorting of the third keys 208c into the third bucket 222c, the fourth bucket 222d and the N bucket 222n. For example, the third vector 218 may comprise the third value of the third bucket 222c, a fourth value of the fourth bucket 222d and an N value of the N bucket 222n.

It bears note that when the vectors are similar to each other, the vectors will have at least partially overlapping bucket assignments. For example, if the first vector 214 is similar to the second vector 216, a subset of the bucket assignments associated with the first vector 214, which is the first and third buckets 222a, 222c, will be the same as a subset of the bucket assignments, which is the second bucket 222b and the third bucket 222c, associated with the second vector 216.

The first vector 214, the second vector 216 and the third vector 218 may be stored in the vector and risk table 220. The vector and risk table 220 includes a series of entries including the first entry 220a, the second entry 220b and the third entry 220c. The first entry 220a comprises first mitigation plan 202a, the first vector 214 and the first risk 202b. The second entry 220b comprises second mitigation plan 204a, the second vector 216 and the second risk 204b. The third entry 220c comprises third mitigation plan 206a, the third vector 218 and the third risk 206b. Thus, each of the first, second and third entries 220a, 220b, 220c comprises different mitigation strategies in association with risks and vector representations of the risks. The vector and risk table 220 is stored in a storage 224.

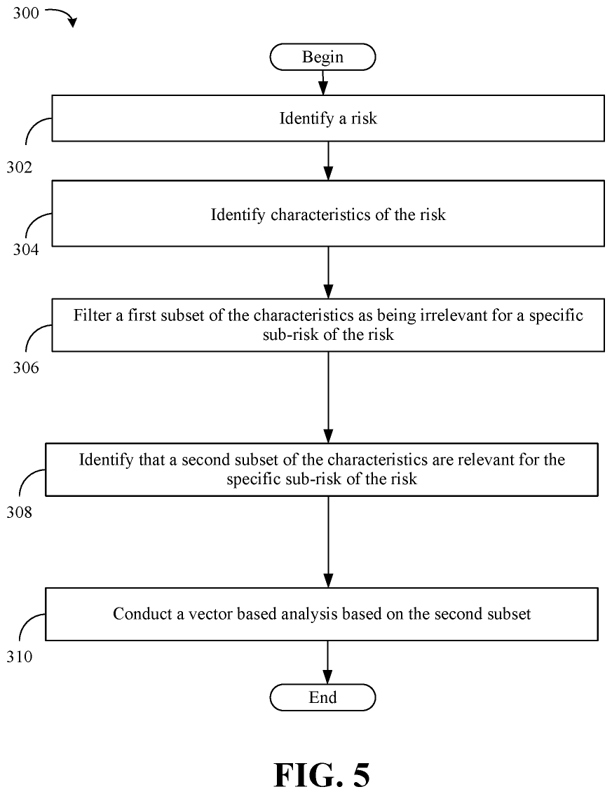

FIG. 5 illustrates a method 300 to conduct risk analysis based on a focused analysis. One or more aspects of method 300 may be implemented as part of and/or in conjunction with the risk classification and mitigation architecture 100 (FIG. 1), natural language analysis process 150 (FIG. 2), risk identification system 160 (FIG. 3), and/or table generation process 200 (FIG. 4). Method 300 may be implemented in a computing device, computing system (e.g., hardware, configurable logic, fixed-function logic hardware, at least one computer readable storage medium comprising a set of instructions for execution, etc.).

Illustrated processing block 302 identifies a risk. Illustrated processing block 304 identifies characteristics of the risk. Illustrated processing block 306 filters a first subset of the characteristics as being irrelevant for a specific sub-risk of the risk. The specific sub-risk may be a specific factor (e.g., unsecured computing devices) that leads to a risk (e.g., network attack vulnerabilities). Illustrated processing block 308 identifies that a second subset of the characteristics are relevant for the specific sub-risk of the risk. Illustrated processing block 310 conducts a vector based analysis based on the second subset. Processing block 310 may include executing a LSH process to generate a vector representing the second subset, and comparing the vector to other vectors and identifying mitigation strategies.

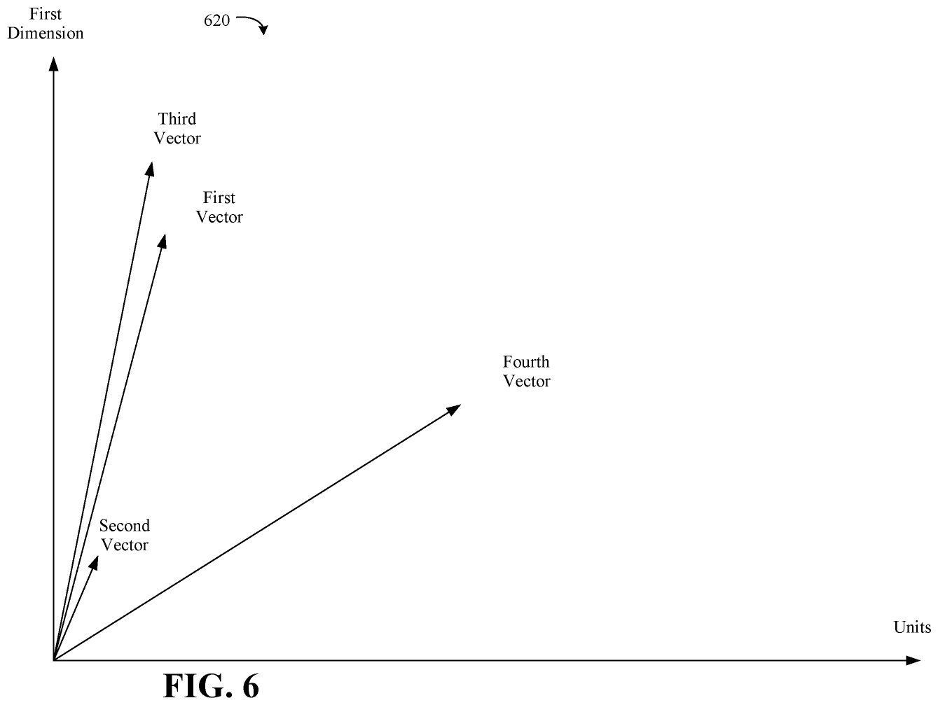

FIG. 6 illustrates a vector graph 620. The vector graph 620 may generally be implemented with the examples described herein, for example, the risk classification and mitigation architecture 100 (FIG. 1), natural language analysis process 150 (FIG. 2), risk identification system 160 (FIG. 3), table generation process 200 (FIG. 4) and/or method 300 (FIG. 5) already discussed. The vector graph 620 includes a first vector, second vector, third vector and fourth vector. The first vector, the second vector, the third vector and the fourth vector may represent different risks, and may be compared to each other to determine which risks are similar to each other and mitigate the risks accordingly.

For example, the first vector may be compared to the second vector. The first vector and the second vector may have similar slopes, but different magnitudes. That is, the second vector has a magnitude that is substantially smaller than the first vector. Since the magnitudes of the first and second vectors are substantially different from each other, the first and second vectors may be deemed to be different from each other and not similar to each other.

The first vector and the third vector may be compared to each other. In this example, the first vector and the third vector have similar slopes (e.g., a difference between the slopes is below a slope threshold) and similar magnitudes (e.g., a difference between a magnitude of the first vector and the third vector is below a magnitude threshold). Thus, the first and third vectors are determined to be similar to each other.

The first vector may be compared to the fourth vector. The first vector and the fourth vector may have substantially different slopes from each other (e.g., a difference between slopes of the first vector and the fourth vector is above the slope threshold). Thus, the first and fourth vectors are determined to be dissimilar from each other. Based on whether the first-fourth vectors are similar to each other, different mitigation strategies may be adopted. For example, a mitigation plan associated with the third vector may be applied to the first vector based on the third vector being similar to the first vector.

System Overview

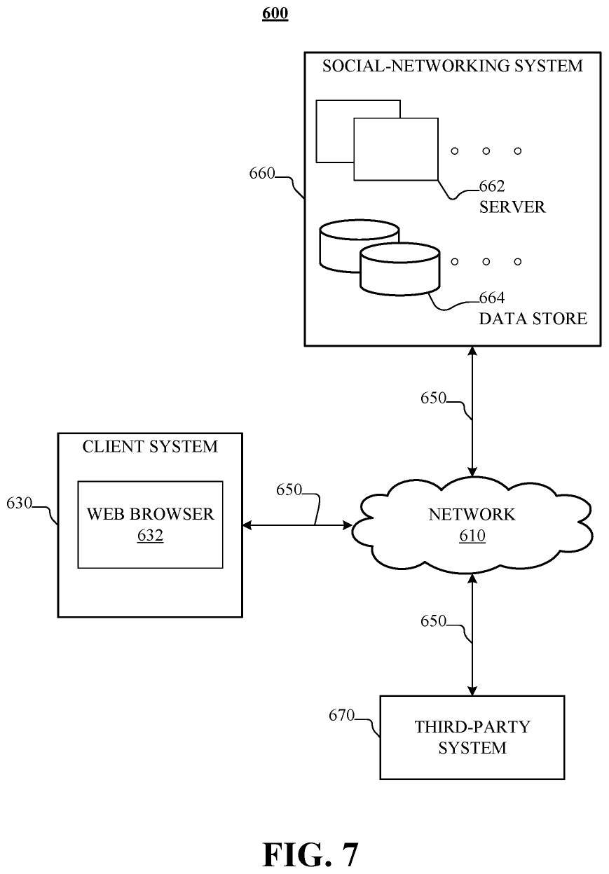

FIG. 7 illustrates an example network environment 600 associated with a social-networking system. Network environment 600 may implement one or more aspects of the risk classification and mitigation architecture 100 (FIG. 1), natural language analysis process 150 (FIG. 2), risk identification system 160 (FIG. 3), table generation process 200 (FIG. 4), method 300 (FIG. 5) and/or vector graph 620 (FIG. 6) already discussed.

Network environment 600 includes a client system 630, a social-networking system 660, and a third-party system 670 connected to each other by a network 610. Although FIG. 7 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 7 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular examples, one or more links 650 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular examples, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular examples, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular examples, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular examples, each server 662 may include hardware, software, or embedded logic components or a combination of two or more such components for carrying out the appropriate functionalities implemented or supported by server 662. In particular examples, social-networking system 660 may include one or more data stores 664. Data stores 664 may be used to store various types of information. In particular examples, the information stored in data stores 664 may be organized according to specific data structures. In particular examples, each data store 664 may be a relational, columnar, correlation, or other suitable database. Although this disclosure describes or illustrates particular types of databases, this disclosure contemplates any suitable types of databases. Particular examples may provide interfaces that enable a client system 630, a social-networking system 660, or a third-party system 670 to manage, retrieve, modify, add, or delete, the information stored in data store 664.

In particular examples, social-networking system 660 may store one or more social graphs in one or more data stores 664. In particular examples, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular examples, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular examples, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular examples, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular examples, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular examples, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular examples, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular examples, social-networking system 660 may include a variety of servers, sub-systems, programs, modules, logs, and data stores. In particular examples, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular examples, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

Social Graphs

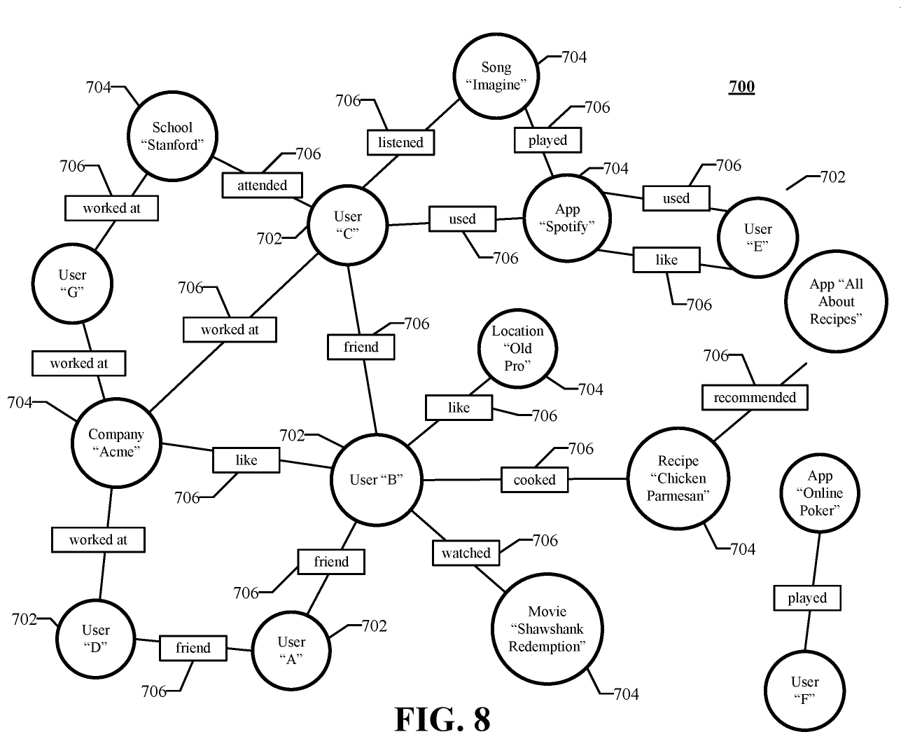

FIG. 8 illustrates example social graph 700. In some examples, the risk classification and mitigation architecture 100 (FIG. 1), natural language analysis process 150 (FIG. 2), risk identification system 160 (FIG. 3), table generation process 200 (FIG. 4), method 300 (FIG. 5) and/or vector graph 620 (FIG. 6) already discussed may access social graph 700 to implement one or more aspects.

In particular examples, social-networking system 660 may store one or more social graphs 700 in one or more data stores. In particular examples, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 8 is shown, for didactic purposes, in a two-dimensional visual map representation. In particular examples, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular examples, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular examples, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular examples, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular examples, a user node 702 may be associated with one or more data objects corresponding to information associated with a user. In particular examples, a user node 702 may correspond to one or more webpages.

In particular examples, a concept node 704 may correspond to a concept. As an example and not by way of limitation, a concept may correspond to a place (such as, for example, a movie theater, restaurant, landmark, or city); a web site (such as, for example, a web site associated with social-network system 660 or a third-party web site associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular examples, a concept node 704 may be associated with one or more data objects corresponding to information associated with concept node 704. In particular examples, a concept node 704 may correspond to one or more webpages.

In particular examples, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular examples, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular examples, a pair of nodes in social graph 700 may be connected to each other by one or more edges 706. An edge 706 connecting a pair of nodes may represent a relationship between the pair of nodes. In particular examples, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 8, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular examples, an edge 706 between a user node 702 and a concept node 704 may represent a particular action or activity performed by a user associated with user node 702 toward a concept associated with a concept node 704. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 660 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 8 between user node 702 for user “E” and concept node 704 for “SPOTIFY”).

In particular examples, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular examples, social-networking system 660 may store an edge 706 in one or more data stores. In particular examples, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

Social Graph Affinity and Coefficient

In particular examples, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular examples, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular examples, social-networking system 660 may use a variety of factors to calculate a coefficient. These factors may include, for example, user actions, types of relationships between objects, location information, other suitable factors, or any combination thereof. In particular examples, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular examples, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular examples, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular examples, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular examples, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or more of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular examples, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular examples, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular examples, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular examples, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular examples, social-networking system 660 may calculate a coefficient based on location information. Objects that are geographically closer to each other may be considered to be more related or of more interest to each other than more distant objects. In particular examples, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular examples, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular examples, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular examples, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular examples, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular examples, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular examples may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

Privacy

In particular examples, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular examples, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular examples, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular examples, privacy settings may allow users to opt in or opt out of having their actions logged by social-networking system 660 or shared with other systems (e.g., third-party system 670). In particular examples, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular examples, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Systems and Methods

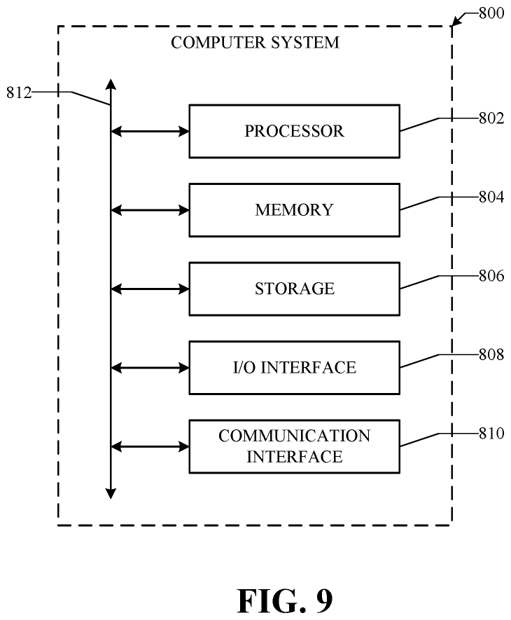

FIG. 9 illustrates an example computer system 800. The system 800 may implement one or more aspects of the risk classification and mitigation architecture 100 (FIG. 1), natural language analysis process 150 (FIG. 2), risk identification system 160 (FIG. 3), table generation process 200 (FIG. 4), method 300 (FIG. 5) and/or vector graph 620 (FIG. 6) already discussed. In particular examples, one or more computer systems 800 perform one or more steps of one or more methods described or illustrated herein. In particular examples, one or more computer systems 800 provide functionality described or illustrated herein. In particular examples, software running on one or more computer systems 800 performs one or more steps of one or more methods described or illustrated herein or provides functionality described or illustrated herein. Particular examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular examples, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular examples, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular examples, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular examples, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular examples, one or more memory management units (MMUs) reside between processor 802 and memory 804 and facilitate accesses to memory 804 requested by processor 802. In particular examples, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular examples, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular examples, storage 806 is non-volatile, solid-state memory. In particular examples, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular examples, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular examples, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular examples, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Thus, technology described herein may support a granular image enhancement selection process. The technology may substantially reduce the memory needed to store listings, the time needed to consummate a transaction and preserve valuable compute resources as well as bandwidth.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. At least one computer readable storage medium comprising a set of instructions, which when executed by a computing device, cause the computing device to:
identify first characteristics of a first risk associated with a system;
apply a locality sensitive hashing process to the first characteristics to map the first characteristics to first buckets of a plurality of buckets;
generate a first vector based on the first characteristics being mapped to the first buckets; and
identify a mitigation plan to at least partially mitigate the first risk based on the first vector.

2. The at least one computer readable storage medium of claim 1, wherein the instructions, when executed, cause the computing device to:
apply a locality sensitive hashing process to second characteristics of a second risk to map the second characteristics to second buckets of the plurality of buckets;
generate a second vector based on the second characteristics being mapped to the second buckets; and
determine that the second risk is similar to the first risk based on a comparison of the first vector to the second vector, wherein at least a first subset of the first buckets is the same as a second subset of the second buckets.

3. The at least one computer readable storage medium of claim 2, wherein the comparison includes executing an eigen-decomposition on the first vector and the second vector to determine whether one or more of the first characteristics are similar to one or more of the second characteristics.

4. The at least one computer readable storage medium of claim 2, wherein the instructions, when executed, cause the computing device to:
identify that the mitigation plan was implemented to at least partially mitigate the second risk;
determine that the mitigation plan is applicable to mitigate the first risk based on the second risk being determined to be similar to the first risk;
apply the mitigation plan to one or more of the first vector or the first risk to generate a third vector; and
determine whether to recommend the mitigation plan to mitigate the first risk based on the third vector.

5. The at least one computer readable storage medium of claim 1, wherein the set of instructions, which when executed by the computing:
receive a natural language input;
apply natural language processing to the natural language input to filter the natural language input into first text that bypasses second text of the natural language input; and
generate the first vector based on the first text.

6. The at least one computer readable storage medium of claim 1, wherein each of the first characteristics is represented as a dimension of the first vector.

7. The at least one computer readable storage medium of claim 1, wherein the locality sensitive hashing process includes a simhash function or a minhash function.

8. A system comprising:
one or more processors; and
a memory coupled to the one or more processors, the memory comprising instructions executable by the one or more processors, the one or more processors being operable when executing the instructions to:
identify first characteristics of a first risk associated with a system;
apply a locality sensitive hashing process to the first characteristics to map the first characteristics to first buckets of a plurality of buckets;
generate a first vector based on the first characteristics being mapped to the first buckets; and
identify a mitigation plan to at least partially mitigate the first risk based on the first vector.

9. The system of claim 8, wherein the one or more processors are further operable when executing the instructions to:
apply a locality sensitive hashing process to second characteristics of a second risk to map the second characteristics to second buckets of the plurality of buckets;
generate a second vector based on the second characteristics being mapped to the second buckets; and
determine that the second risk is similar to the first risk based on a comparison of the first vector to the second vector, wherein at least a first subset of the first buckets is the same as a second subset of the second buckets.

10. The system of claim 9, wherein the comparison includes executing an eigen-decomposition on the first vector and the second vector to determine whether one or more of the first characteristics are similar to one or more of the second characteristics.

11. The system of claim 9, wherein the one or more processors are further operable when executing the instructions to:
identify that the mitigation plan was implemented to at least partially mitigate the second risk;
determine that the mitigation plan is applicable to mitigate the first risk based on the second risk being determined to be similar to the first risk;
apply the mitigation plan to one or more of the first vector or the first risk to generate a third vector; and
determine whether to recommend the mitigation plan to mitigate the first risk based on the third vector.

12. The system of claim 8, wherein the one or more processors are further operable when executing the instructions to:
receive a natural language input;
apply natural language processing to the natural language input to filter the natural language input into first text that bypasses second text of the natural language input; and
generate the first vector based on the first text.

13. The system of claim 8, wherein each of the first characteristics is represented as a dimension of the first vector.

14. The system of claim 8, wherein the locality sensitive hashing process includes a simhash function or a minhash function.

15. A method comprising:
identifying first characteristics of a first risk associated with a system;
applying a locality sensitive hashing process to the first characteristics to map the first characteristics to first buckets of a plurality of buckets;
generating a first vector based on the first characteristics being mapped to the first buckets; and
identifying a mitigation plan to at least partially mitigate the first risk based on the first vector.

16. The method of claim 15, further comprising:
applying a locality sensitive hashing process to second characteristics of a second risk to map the second characteristics to second buckets of the plurality of buckets;
generating a second vector based on the second characteristics being mapped to the second buckets; and
determining that the second risk is similar to the first risk based on a comparison of the first vector to the second vector, wherein at least a first subset of the first buckets is the same as a second subset of the second buckets.

17. The method of claim 16, wherein the comparison includes executing an eigen-decomposition on the first vector and the second vector to determine whether one or more of the first characteristics are similar to one or more of the second characteristics.

18. The method of claim 16, further comprising:
identifying that the mitigation plan was implemented to at least partially mitigate the second risk;
determining that the mitigation plan is applicable to mitigate the first risk based on the second risk being determined to be similar to the first risk;
applying the mitigation plan to one or more of the first vector or the first risk to generate a third vector; and
determining whether to recommend the mitigation plan to mitigate the first risk based on the third vector.

19. The method of claim 15, further comprising:
receiving a natural language input;
applying natural language processing to the natural language input to filter the natural language input into first text that bypasses second text of the natural language input; and
generating the first vector based on the first text.

20. The method of claim 15, wherein:
each of the first characteristics is represented as a dimension of the first vector; and
the locality sensitive hashing process includes a simhash function or a minhash function.
